(19) United States
(12) Patent Application Publication
(10) Pub. No.: US 2006/0197728 A1
(43) Pub. Date: Sep. 7, 2006

(54) Liquid crystal display

(75) Inventors: Mitsuyoshi Miyai, Ibaraki-shi (JP); Masakazu Okada, Kyoto-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/359,922

(22) Filed: Feb. 22, 2006

(30) Foreign Application Priority Data
Mar. 3, 2005 (JP) 2005-058653

(51) Int. Cl. G09G 3/36

(52) U.S. Cl. 345/92

(57) ABSTRACT

This invention can provide a liquid crystal display unit which can employ any liquid crystal material without being limited by its dielectric constant and initialize liquid crystal layer at low voltages. A liquid crystal display unit comprising pixel electrodes which are disposed in a matrix, common electrode and one of electrodes of supplementary capacitor which is opposite to the pixel electrode, liquid crystal layer containing a memory-type liquid crystal material sandwiched between the pixel electrode and the common electrode, and switching elements which respectively turn on and off voltage to pixel electrodes, wherein the liquid crystal display unit changes the states of liquid crystals to perform image erasing, writing, and displaying operations in sequence while driving the common electrode and one of electrodes of the supplementary capacitor so that the electrodes may have an identical potential.

This application is based on Japanese Patent Application No. 2005-058653 filed on Mar. 3, 2005, in Japanese Patent Office, the entire content of which is hereby incorporated by reference.

### TECHNICAL FIELD

This invention relates to a liquid crystal display unit, particularly to an active matrix type liquid crystal display unit which uses memory-type liquid crystals.

### BACKGROUND

A liquid crystal display unit features low power consumption thinness, and lightweight and has been preferably used for portable devices such as cell phones, portable personal computers, etc. As these devices are driven by a built-in battery, their liquid crystal display units are required to consume as little power as possible. Among liquid crystal display units, a high reflective liquid crystal display unit without a backlight has been expected as a display device for portable devices since the high reflective liquid crystal display unit uses no backlight and has a good visibility even under bright illumination.

Current general high reflective liquid crystal display units employ nematic liquid crystals such as TN, STN, and the like because of easy driving and good response. However, these liquid crystal display units have no memory property and must always apply voltages to liquid crystals to display images. Therefore, this is a power consumption problem the display unit cannot avoid.

Recently liquid crystal display units which employ liquid crystals having a memory property (hereinafter called “memory-type liquid crystal”) have been proposed. This kind of liquid crystal display unit has a feature (memory property) that keeps on displaying a written image semi-permanently even after electric fields for crystals are removed. In other words, it is only when an image is rewritten that the display unit consumes electric-power. No additional electric power is required to keep on displaying the image. Therefore, this display unit is much expected as a low power-consumption display unit to display still images and characters.

Cholesteric liquid crystals and ferroelectric liquid crystals have been well known as memory-type liquid crystals. The memory-type liquid crystals excel at power saving, but they have also problems as follows. Their driving manner is complicated because an operation to erase written images is needed, further they requires high voltages to be driven, and their rewriting speed is slow.

Below will be explained the cholesteric liquid crystals. The cholesteric liquid crystal has three liquid crystal phases: Homeotropic (nematic), Planar, and Focal-conic. Homeotropic alignment is a liquid crystal phase in which a voltage is applied to liquid crystal and all long axes of liquid crystalline molecules (hereinafter called “liquid crystal axes” are aligned along the direction of electric field. So, the liquid crystal layer seems to be transparent. The planar alignment is the state which appears after the electric field is suddenly removed in the Homeotropic alignment state. In this state, liquid crystalline molecules are spirally aligned and the center axis of the spiral (hereinafter called “a spiral axis”) is perpendicular to a substrate. When a light ray comes along the spiral axis, the crystalline molecule in the planar alignment selectively reflects a ray of a wavelength expressed by λ=n·p (where λ is a wavelength, n is a mean refractive index, and p is a distance (spiral pitch) at which a liquid crystalline molecule is twisted 360°) and lets rays of shorter wavelengths pass through the crystalline molecule. When an adequate voltage is applied to a liquid crystal layer in the planar state, the liquid crystal layer shows a focal conic state in which the liquid crystal layer aligns the spiral axis parallel to the substrate. When rays hit the substrate in this status perpendicularly to the spiral axis or to the substrate, the liquid crystal layer passes rays whose wavelength is close to the spiral pitch p without reflecting or scattering the rays and scatters rays whose wavelength is shorter.

Therefore it is possible to display a selectively-reflected color when the liquid crystal layer is in the planar state and a black color when the liquid crystal layer is in the focal conic state by setting the wavelength of the selectively-reflected ray for the visible light region and providing a light absorption layer opposite to the observation surface of the liquid crystal display element. Further, by setting the wavelength of the selectively-reflected ray for the infrared light region and providing a light absorption layer opposite to the observation surface of the liquid crystal display element, it is possible to display a black color in the planar state since the liquid crystal layer in the planar state reflects rays of wavelengths in the infrared light region but passes rays of wavelengths in the visible light region, and a white color due to scattering of visible light in the focal-conic status.

FIG. 1 shows a constituent structure of a basic liquid crystal cell (10). FIG. 2 shows how the reflectance of liquid crystal cell 10 changes by applied voltages.

In FIG. 1, basic liquid crystal cell 10 comprises glass substrates 1 and 2, liquid crystal layer 3 of cholesteric liquid crystal, transparent electrodes 4 and 5 by ITO and the like, and light absorption layer 6 which is painted or made black. Transparent electrodes 4 and 5 are respectively connected to power supply 9 with conductors 7 and 8.

FIG. 2 shows the relationship between voltages applied to liquid crystal cell 10 and reflectances of liquid crystal cell 10 measured from the observation surface of the liquid crystal cell (opposite to light absorption layer 6). In FIG. 2, the horizontal axis denotes voltage applied to liquid crystal cell 10 and the vertical axis denotes reflectance of the liquid crystal after the voltage is removed. Solid line 11 shows the reflectance of liquid crystal cell 10 measured when the liquid crystal initially in the planar state becomes stable after the applied voltage is removed. Dashed line 12 shows the reflectance of liquid crystal cell 10 measured when the liquid crystal initially in the focal conic state becomes stable after the applied voltage is removed. Dashed line 12 is on dashed line 11 between voltages V3 and V2 and at voltages of V1 and higher.

The cholesteric liquid crystal has a hysteresis property. As explained above, even when an identical voltage is applied to the cholesteric liquid crystal, the crystal will not take the original state. The states depend on the immediate history (that is, its previous state). Therefore, it is necessary to initialize the state of a liquid crystal like a cholesteric liquid crystal which has a hysteresis property before writing an image on it.

First will be explained the behavior of solid line 11. Before a voltage applied, the liquid crystal is in the planar state and the reflectance is R_{P}. A pulse voltage of, for example, 5 ms width is applied to liquid crystal cell 10 from power supply 9. If a pulse voltage of V4 or less is applied to liquid crystal cell 10, the reflectance of cell 10 hardly varies. When the applied voltage is between V4 and V3, the reflectance reduces as the voltage goes up. In this voltage range, liquid crystal layer 3 has both planar and focal-conic states. At voltage V3, almost the whole liquid crystal layer 3 is in the focal-conic state. Voltage V3 is called a focal-conic voltage. When the applied voltage is between V3 and V2, the reflectance of cell 10 hardly varies. In the voltage range of V2 to V1, the reflectance increases as the voltage goes up. In this voltage range, liquid crystal layer 3 has a mixture of planar and focal-conic states. At voltage V1, almost the whole liquid crystal layer 3 is in the planar state. In the voltage range of V1 or higher, the reflectance remains unchanged while the voltage goes up. When a voltage in this range is applied, the liquid crystal layer is in the homeotropic state. So, voltage V1 is called homeotropic voltage. Using this property, it is possible to cause liquid crystal layer 3 to display an image of an arbitrary density by applying a voltage of V1 or higher to liquid crystal layer 3 to initialize the state of liquid crystal layer 3 to a planer state, and then applying a voltage in the range of V4 to V2 or V2 to V1.

Next will be explained the behavior of dashed line 12. Before a voltage is applied, the liquid crystal is in the focal-conic state and the reflectance is RF. A pulse voltage of, for example, 5 ms width is applied to liquid crystal cell 10 from power supply 9. If a pulse voltage of V5 or less is applied to liquid crystal cell 10, the reflectance of cell 10 hardly varies. In this voltage range, liquid crystal layer 3 remains in the focal-conic state. In the voltage range of V5 to V1, the reflectance increases as the voltage goes up. In this voltage range, liquid crystal layer 3 has a mixture of planar and focal-conic states. At voltage V1, almost the whole liquid crystal layer 3 is in the planar state. In the voltage range of V1 or higher, the reflectance remains unchanged while the voltage goes up. When a voltage in this range is applied, liquid crystal layer 3 is in the homeotropic state. Using this property, it is possible to cause liquid crystal layer 3 to display an image of an arbitrary density by applying a voltage in the range of V3 to V2 to liquid crystal layer 3 to initialize the state of liquid crystal layer 3 to a focal-conic layer, and then applying a voltage in the range of V5 to V1.

Next will be explained how a liquid crystal matrix is driven. Two methods have been known to drive cholesteric liquid crystal elements in matrix: Simple matrix driving and active matrix driving. One of simple matrix driving methods is disclosed by Non-Patent Document 1.

One of demerits of the simple matrix driving methods is slow writing speed. Cholesteric liquid crystals unlike STN liquid crystals cannot be driven by the root-mean-square values of voltages applied to the liquid crystals. So, it is necessary to determine the state of liquid crystals on each selected line in the liquid crystal matrix. Accordingly, when a pulse voltage of, for example, 5 ms width is applied to determine the state of liquid crystals, a total of 5 seconds (=5 ms×1000 lines) is required to scan a liquid crystal panel of 1000 lines. Contrarily, the active matrix driving method can scan very fast since it keeps on applying a voltage, which is stored in the liquid crystal layer or a supplementary capacitor, to pixels on the lines with which selection has ended, and the time required to select lines depends on the time to charge the liquid crystal layer and the supplementary capacitor.

Patent Document 1 discloses a technology using the active matrix driving method to drive cholesteric liquid crystals. FIG. 8 is a schematic circuit diagram of a liquid crystal display unit disclosed by Patent Document 1. The liquid crystal display unit comprises liquid crystal layer 41 which employs a liquid crystal material which shows cholesteric phase, storage capacity 42, TFT switching element 43, scanning line 44 which connects the gate of each TFT 43 which is disposed along a row of the matrix, signal line (45a and 45b) which connects the source of each TFT 43 which is disposed along a column of the matrix, common line 46 which feeds common signal V_{COM} (usually ground potential) to liquid crystal layer 41, Y driver 47 (scanning line driver) which supplies scanning signals to scanning line 44, XU driver 48a and XD driver 48b (signal line driver) which respectively supply display signals to signal lines 45a and 45b, and signal line 49 which supplies a charge-retaining potential to storage capacity 42. The display screen can be initialized by applying an erasing signal to signal line 49.

[Patent Document 1] Japanese Non-examined Patent Publication H10-105085

[Non-patent Document 1] SID'98 Hashimoto: Minolta (International Symposium Digest of Technical Paper Vol. 29, page 897, 1998)

Patent Document 1 discloses the following technology: In the case of initializing the display screen by applying a voltage to signal line 49, voltage VLD to be applied to liquid crystal layer 41 is expressed by Equation 1.
V_{LCD}=C_{cs}/(C_{LCD}+C_{cs})·(V_{cs}−V_{COM}) (Equation 1)

where

V_{cs}: Voltage applied to signal line 49

V_{COM}: Common signal voltage

C_{LCD}: Capacitance of liquid crystal layer 41

C_{cs}: Storage capacity

In other words, only part C_{cs}/(C_{LCD}+C_{cs}) of voltage (V_{cs}−V_{COM}) applied between common line 46 and signal line 49 is actually applied to liquid crystal layer 41 and the remaining part of the voltage is applied to storage capacity 42.

The dielectric constant of the cholesteric liquid crystal is higher than that of TN and STN liquid crystals and capacitance C_{LCD} of liquid crystal layer 41 is great. Therefore the ratio of voltage actually applied to initialize liquid crystal layer 41 is little to the voltage applied between common line 46 and signal line 49. Generally, the voltage (i.e. V1 in FIG. 2) to initialize cholesteric liquid crystals is much higher than voltages to drive TN and STN liquid crystals. For example, it is about dozens of volts to 100V. Therefore, a fairly high voltage must be applied between common line 46 and signal line 49. However, it is not preferable to apply a very high voltage between common line 46 and signal line 49 in consideration of power efficiency, high voltage switching noises, and circuit reliability.

Therefore it is necessary that part of the voltage applied between common line 46 and signal line 49 is effectively applied to liquid crystal layer 41. There are two ways for that purpose. One way is to increase capacitance C_{cs} of storage capacity 42 and the other is to reduce capacitance C_{LCD} of liquid crystal layer 41. However, to increase capacitance C_{cs} of storage capacity 42, the area of storage capacity 42 must be increased. This will reduce the aperture ratio of the liquid crystal display unit and deteriorate the display quality. Therefore, the way of increasing capacitance C_{cs} of storage capacity 42 is limited, and the other way of reducing capacitance C_{LCD} of liquid crystal layer 41 must be adopted instead.

There are two ways to reduce capacitance C_{LCD} of liquid crystal layer 41: to reduce the area of liquid crystal layer 41 and to use liquid crystal materials of low dielectric constant. However, when the area of liquid crystal layer 41 is reduced, the aperture ratio of the liquid crystal display unit is reduced, too. This deteriorates the display quality. Therefore, it is necessary to use liquid crystal materials of low dielectric constant. However, liquid crystal materials of low dielectric constant generally require higher driving voltage than liquid crystal materials of high dielectric constant. So, when liquid crystal layer 41 uses a liquid crystal material of very low dielectric constant, it is necessary to fairly increase the voltage between common line 46 and signal line 49. That is to say, it is necessary to limit the dielectric constant of liquid crystal materials.

It is necessary to select an optimum liquid crystal material for liquid crystal layer 41 of the liquid crystal display unit in consideration of display contrast, response, temperature coefficient, and so on. However, as for the technology disclosed by Patent Document 1, the dielectric constant is also limited in addition to the above properties. As the result, liquid crystal materials must be selected in a very limited range and it is impossible to select optimum liquid crystal materials for the liquid crystal display unit.

### SUMMARY

Consequently, an object of this invention is to provide a liquid crystal display unit whose liquid crystal material can be freely selected independently of dielectric constant and whose initialization voltage of the liquid crystal layer is low.

In view of forgoing, an object of this invention is to solve at least one of the problems, and to provide new apparatus. The apparatus is a Liquid Crystal Display having

a plurality of pixels, comprising:

a plurality of pixel electrodes;

a common electrode which faces the plurality of pixel electrodes;

a liquid crystal layer which contains a memory-type liquid crystal material provided between the plurality of pixel electrodes and the common electrode;

a plurality of supplementary capacitors which are provided corresponding to the pixel electrodes;

a plurality of switching elements which are provided corresponding to the pixel electrodes to control connection and disconnection of a voltage to the plurality of the pixel electrodes, and

a common power supply which controls a voltage to the common electrode;

wherein the plurality of pixels include the pixel electrodes, the common electrode, the liquid crystal layer, the supplementary capacitors and the switching elements, and one terminals of the supplementary capacitors are electrically connected to the corresponding pixel electrodes, the other terminals of the supplementary capacitors are electrically connected to the common electrode, and the switching elements and the common power supply operate to update a state of the liquid crystal layer in the following order: an erasing operation, a writing operation and a displaying operation.

According to another aspect of the present invention, the apparatus is a Liquid Crystal Display having a plurality of pixels, comprising:

a plurality of pixel electrodes;

a common electrode which faces the plurality of pixel electrodes;

a liquid crystal layer which contains a memory-type liquid crystal material provided between the plurality of pixel electrodes and the common electrode;

a plurality of supplementary capacitors which are provided corresponding to the pixel electrodes and are connected to the corresponding pixel electrodes;

a plurality of switching elements which are provided corresponding to the pixel electrodes to control connection and disconnection of a voltage to the plurality of the pixel electrodes, and

a common power supply which controls a voltage to the common electrode, controls the voltage and is connected to the other terminals of the supplementary capacitors and the common electrode;

a gate driver circuit which controls the switching elements on a row to row basis to select a pixel row;

a source driver circuit which supplies a voltage to be applied to the row of pixels selected by the gate driver circuit to the pixel electrodes individually;

wherein the plurality of pixels include the pixel electrodes, the common electrode, the liquid crystal layer, the supplementary capacitors and the switching elements.

According to another aspect of the present invention, the apparatus is a Liquid Crystal Display having a plurality of pixels, comprising:

a plurality of pixel electrodes;

a common electrode which faces the plurality of pixel electrodes;

a liquid crystal layer which contains a cholesteric liquid crystal material having memory property provided between the plurality of pixel electrodes and the common electrode;

a plurality of supplementary capacitors which are provided corresponding to the pixel electrodes and are connected to the corresponding pixel electrodes;

a plurality of switching elements which are provided corresponding to the pixel electrodes to control connection and disconnection of a voltage to the plurality of the pixel electrodes, and

a common power supply which controls a voltage to the common electrode, controls the voltage and is connected to the other terminals of the supplementary capacitors and the common electrode;

a gate driver circuit which controls the switching elements on a row to row basis to select a pixel row;

a source driver circuit which supplies a voltage to be applied to the row of pixels selected by the gate driver circuit to the pixel electrodes individually;

wherein the plurality of pixels include the pixel electrodes, the common electrode, the liquid crystal layer, the supplementary capacitors and the switching elements.

### BRIEF DESCRIPTION OF THE DRAWINGS

FIG. 1 is a constituent structure of a basic liquid crystal cell to explain an operation of the cholesteric liquid crystal.

FIG. 2 shows how the reflectance of a liquid crystal cell changes by applied voltages to explain an operation of the cholesteric liquid crystal.

FIG. 3 shows the schematic circuit diagram of a liquid crystal display unit which is a first embodiment of this invention.

FIG. 4 shows voltage transitions of each component of a liquid crystal display unit which is a first embodiment of this invention.

FIG. 5 shows voltage transitions of each component of a liquid crystal display unit which is a second embodiment of this invention.

FIG. 6 shows voltage transitions of each component of a liquid crystal display unit which is a third embodiment of this invention.

FIG. 7 shows voltage transitions of each component of a liquid crystal display unit which is a fourth embodiment of this invention.

FIG. 8 is a constituent structure of a liquid crystal display unit which is made by a conventional technology.

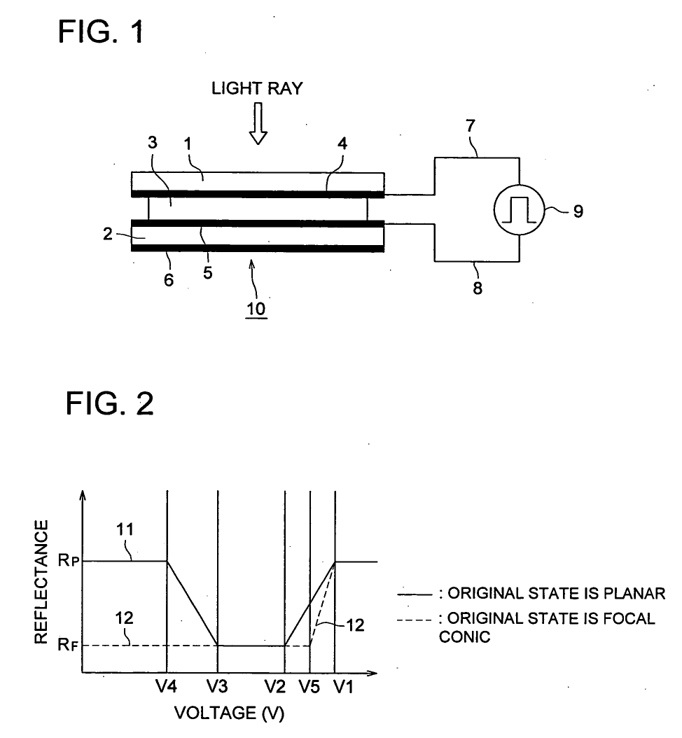

### DETAILED DESCRIPTION OF THE PREFFERED EMBODIMENT

Embodiments of this invention will be explained below with reference to accompanying drawings.

### First Embodiment

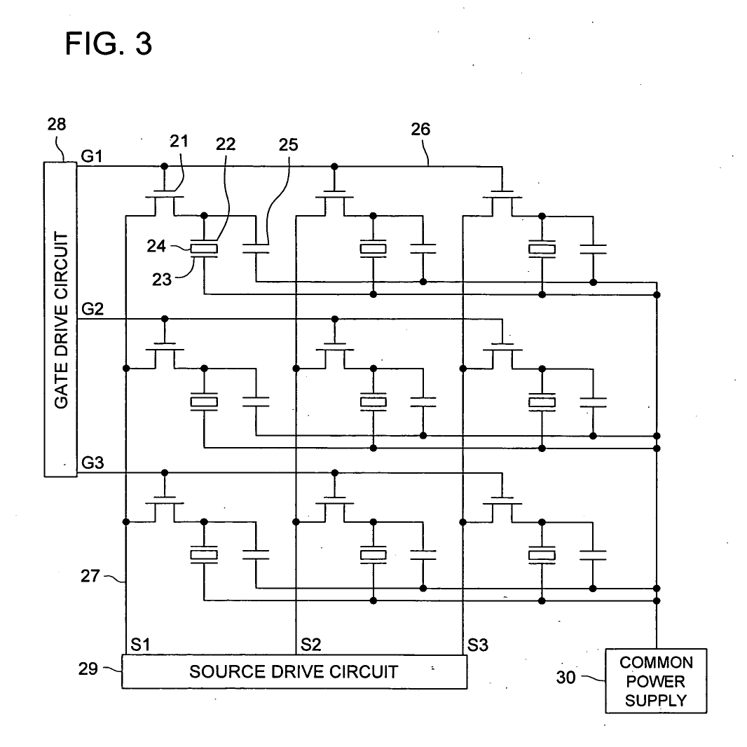

FIG. 3 shows the schematic circuit diagram of a liquid crystal display unit which is a first embodiment of this invention. For simplicity, FIG. 3 uses a using liquid crystal display unit of a 3-row by 3-column pixel matrix. This invention is not limited to this number of pixels. In FIG. 3, TFT (switching element) 21 controls voltage application and shut-off of pixel electrode 22. Liquid crystal layer 24 is sandwiched between pixel electrode 22 and common electrode 23. One of the electrodes of supplementary capacitor 25 which is closer to TFT 21 is part of pixel electrode 22 and the other electrode is connected to common electrode 23. Supplementary capacitor 25 works to hold the voltage applied to pixel electrode 22 when TFT 21 is in the shut-off state. A single pixel comprises TFT 21, pixel electrode 22, common electrode 23, liquid crystal layer 24 and supplementary capacitor 25. Gate line 26 from gate driver circuit 28 connects gate terminals of TFTs 21 of pixels together which are disposed in a row. Source lines 27 from source driver circuit 29 connects source terminals of TFTs 21 of pixels together which are disposed in a column. Gate driver circuit 28 has three gate lines (G1, G2, and G3) and selects a gate line by outputting a voltage to the line to control the ON/OFF state of TFT 21 and apply a voltage to it. Source driver circuit 29 has three source lines (S1, S2 and S3) and outputs a voltage which should be applied to pixel electrode 22 of the selected line to these source lines. Common power supply 30 applies a require voltage to common electrode 23 and one of the electrodes of supplementary capacitor 25.

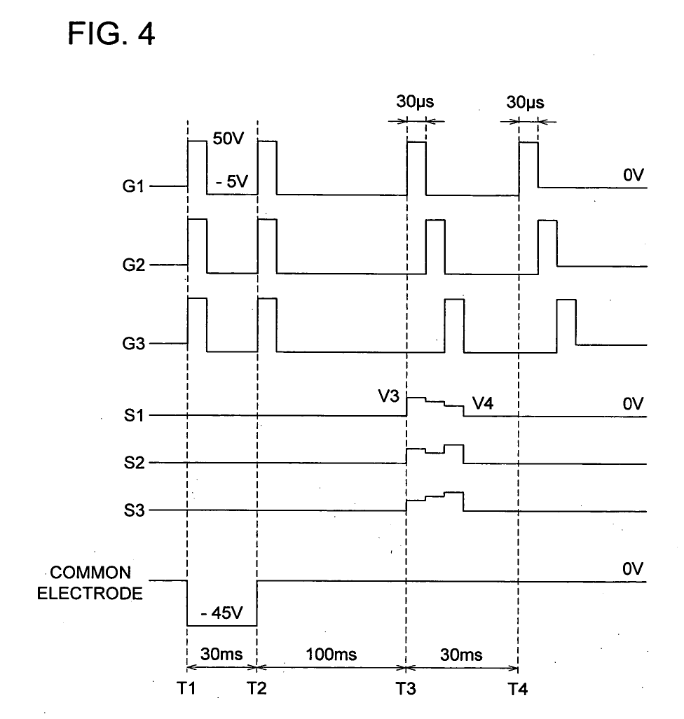

FIG. 4 shows voltage transitions in erasing, writing, and displaying operation of the liquid crystal display unit of this embodiment. Operations of the liquid crystal display unit will be explained below referring to FIG. 4. In FIG. 4, G1, G2, and G3 are respectively voltages of gate lines G1, G2, and G3. S1, S2, and S3 are respectively voltages of source lines S1, S2, and S3. “Common electrode” means a voltage of the common electrode. Timing T1, T2, T3, and T4 are respectively voltage rise timings of gate line G1. T1 is a timing to start an erasing operation. T3 is a timing to start a writing operation. T4 is a timing to start a displaying operation.

(Erasing operation) In FIG. 4, at timing T1, a voltage of, for example, 50V is applied to gate lines G1, G2, and G3 to turn on TFT 21. A voltage of source lines S1, S2, and S3 is applied to pixel electrode 22. Simultaneously, a voltage of −45V, whose absolute value is greater than homeotropic voltage V1, is output to the common electrode. The source lines remain at 0V. Then, a voltage of −5V is output to turn off TFT 21. In this case, it is preferable that a TFT 210N period during which 50V is output to gate lines (G1, G2, and G3) is long enough to charge up liquid crystal layer 24 and supplementary capacitor 25 through TFT 21. For example, it can be dozens of μs. With this, a voltage of 45V is applied to liquid crystal layer 24 and the layer (24) shows homeotropic state. In FIG. 4, this voltage is retained for 30 ms to fully keep the liquid crystal layer in the homeotropic state.

Then, at timing T2, a voltage of 50V is temporarily output to gate lines (G1, G2, and G3) to turn on TFTs 21 connected to the gate lines (G1, G2, and G3). Then, a voltage of −5V is output to turn off TFT 21. Simultaneously when a voltage of 50V is output to the gate lines, a voltage of 0V is output to common electrode 23. In this case, it is preferable that a TFT 10N period during which 50V is output to gate lines (G1, G2, and G3) is long enough to discharge up liquid crystal layer 24 and electrode 22 of supplementary capacitor 25 through TFT 21. For example, it can be dozens of μs. With this, the voltage applied to liquid crystal layer 24 rapidly changes from 45V to 0V. Therefore liquid crystal layer 24 changes the state from homeotropic state to planar state. With this, liquid crystal layer 24 is initialized. In this case, liquid crystal layer 24 temporarily enters a planar state whose spiral pitch is twice the original pitch (so-called a transient planer state) and then enters the planar state instead of directly entering the planar state. It takes about 1 ms for this homeotropic-to-planar transition. Therefore it is possible to start a writing operation 1 ms later after the voltage applied to the liquid crystal layer becomes 0V, but this embodiment starts a writing operation 100 ms later. The reason why a writing operation is not started immediately after liquid crystal is initialized to the planar state will be described later.

(Writing operation) At timing T3, a voltage of 50V is applied to gate line G1 to start a writing operation. At this time, voltages of V4 to V3 (see FIG. 2) corresponding to pixel writing densities are output to source lines (S1, S2, and S3) In this case, it is preferable that a TFT 210N period during which 50V is output to gate line G1 is long enough to charge up liquid crystal layer 24 and supplementary capacitor 25 through TFT 2. For example, this embodiment uses 30 μs as the time period. Then, a voltage of −5V is output to gate line G1 and TFT 21 enters the OFF state. In this way, the voltage applied to liquid crystal layer 24 is retained for 30 ms until gate line G1 becomes 50V. Part of liquid crystalline molecules in the liquid crystal layer 24 enters the focal-conic state and an image density corresponding to the applied voltage is written. During a time period between T3 and T4, the applied voltage is retained between both electrodes of the liquid crystal layer 24. It takes at least several milliseconds (ms) to change the state of the crystal to a desired state. The time period should preferably be 10 ms or more.

In a writing operation, a pulse voltage of 50V is output to gate lines G1, G2, and G3 in this order to scan gate lines G1, G2, and G3. Images are written on pixels on the row to which the pulse voltage of 50V is applied.

Next will be explained why a writing operation is not started immediately after liquid crystal layer 24 is initialized to the planar state. A time period between T2 and T3 is to stabilize liquid crystal layer 24. Immediately after initialized to the planar state, the alignment of liquid crystalline molecules in liquid crystal layer 24 is not stable yet. When all pixels to be initialized are initialized simultaneously as in this embodiment and rows are respectively scanned for writing operation, a time period between initialization and a writing operation varies from pixel to pixel. Therefore, when a writing operation is started immediately after liquid crystal layer 24 is initialized to the planar state, displaying may not be even because a time period between initialization and writing operation varies from pixel to pixel. Therefore, it is preferable to fully wait until the alignment of the initialized liquid crystalline molecules becomes stable. The waiting time should preferably be 50 ms or more.

(Displaying operation) From T4 (which is 30 ms after T3), a pulse voltage of 50V is applied to gate lines G1, G2, and G3 in this order to turn on TFTs 21 connected to gate lines G1, G2, and G3 sequentially. In this state, the common electrode and source lines (S1, S2, and S3) respectively have a potential of 0V. A voltage applied to each liquid crystal layer 24 becomes 0V sequentially. In this case, it is preferable that the duration of the 50V pulse voltage is long enough to discharge voltages of liquid crystal layer 24 and supplementary capacitor 25 through TFT 21. For example, this embodiment uses 30 μs as the time period. In this way, liquid crystal 24 is applied a voltage of 0V and the liquid crystal display unit starts displaying operation.

In this embodiment, liquid crystal layer 24 and supplementary capacitor 25 are connected in parallel with each other. Unlike a conventional liquid crystal display unit which connects liquid crystal layer 24 and supplementary capacitor 25 in series, this embodiment can apply the entire common supply voltage to every liquid crystal layer 24 without voltage from common power supply 30 being divided by liquid crystal layer 24 and supplementary capacitor 25. Therefore, although the conventional technology must select liquid crystal materials for liquid crystal layer 24 in a very limited range of dielectric constant to apply voltage efficiently, this embodiment can select arbitrary liquid crystal materials. Further, since voltages applied to source lines 27 and common electrode 23 are all applied to liquid crystal layers 24, the voltage of common power supply 30 need not be higher than that of the conventional technology. Further, this embodiment is superior in power saving, noise reduction, and circuit reliability to the conventional technology. Furthermore, since this embodiment uses a single common power supply (30) to drive both common electrode 23 and supplementary capacitor 25 although the conventional technology uses two power supplies to drive them, the circuit can be simplified and low in production cost.

It is not source driver circuit 29 but common power supply 30 that supplies homeotropic voltage V1 to liquid crystal layer 24 for erasing operation in this embodiment. Meanwhile, a voltage which is output from the source driver circuit is at most V3 which is used for writing operation. Therefore, this embodiment need not to use a high-voltage circuit for the source driver circuit. Further, since this embodiment generally uses integrated circuit, it can use low-voltage and inexpensive integrated circuit for the source driver circuit. Consequently, the invention can provide a very inexpensive liquid crystal display unit.

This embodiment applies pulse voltages of 30 μs width to gate lines (G1, G2, and G3) for writing operation. Therefore, a liquid crystal display unit of, for example, 1000 rows can be rewritten by a total of 190 ms (=130 ms for erasing operation+30 ms for write-scanning+30 ms for display scanning). Contrarily it takes about 5 s to rewrite a liquid crystal display unit of a passive matrix of 1000 rows assuming a voltage application time for each row is 5 ms.

Although this embodiment outputs, for example, 50V and −5V to gate lines, any voltages can be used as long as the voltages can turn on and off TFT 21 substantially.

### Second Embodiment

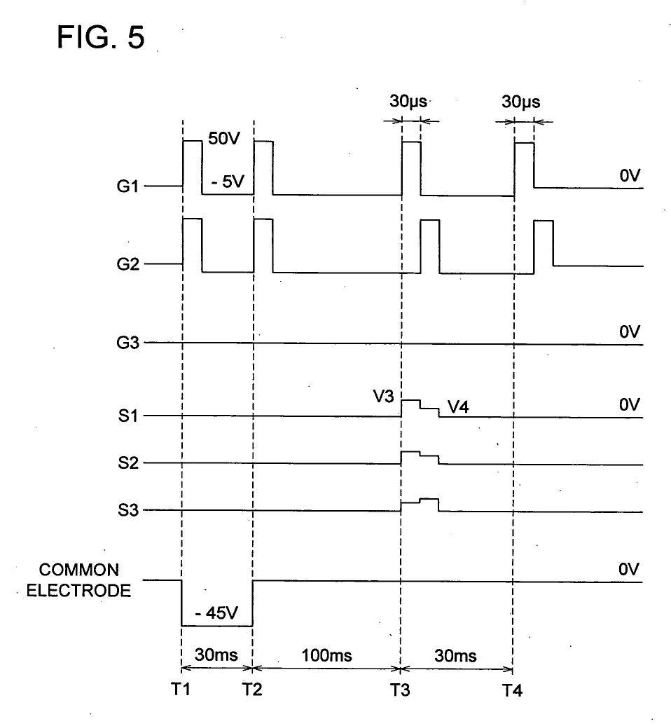

FIG. 5 shows voltage transitions of each component of a liquid crystal display unit which is a second embodiment of this invention. FIG. 5 and FIG. 4 use the same parts for transitions of voltages. Operations of the liquid crystal display unit will be explained below referring to FIG. 5. The second embodiment is the same as the first embodiment but only the rewriting operation is different. The first embodiment performs an erasing operation on all pixels in the liquid crystal display unit simultaneously and a writing operation in the similar way. However, the second embodiment performs an erasing operation on only pixels connected to gate lines (G1 and G2) and a writing operation on the same pixels, too. In other words, these operations are for partial rewriting. Specifically, these operations rewrite only part of a display image to be changed instead of rewriting all pixels.

FIG. 5 can be read in the same manner as FIG. 4. In the erasing operation, at T1 and T2, a pulse voltage is applied to only gate lines G1 and G2 to erase image on only pixels connected to the gate lines. Since the voltage of gate line G3 remains 0V, TFT 21 connected to the gate line remains off. Therefore, a voltage will not be applied to liquid crystal layer 24 related to gate line G3 even when the voltage of the common electrode is −45V. Also in the writing operation starting at T3 and the displaying operation starting at T4, only gate lines G1 and G2 are scanned to write and display image.

In this embodiment, pixels related to gate line G3 keeps on displaying and only pixels related to gate lines G1 and G2 perform rewriting.

Since this embodiment drives only part of the liquid crystal display unit, power consumed to rewrite part of pixels is less than that consumed to rewrite all pixels. Naturally, time for writing can be reduced. Further, this embodiment can perform natural writing since only pixels related to images to be changed are rewritten and other pixels are left unwritten.

### Third Embodiment

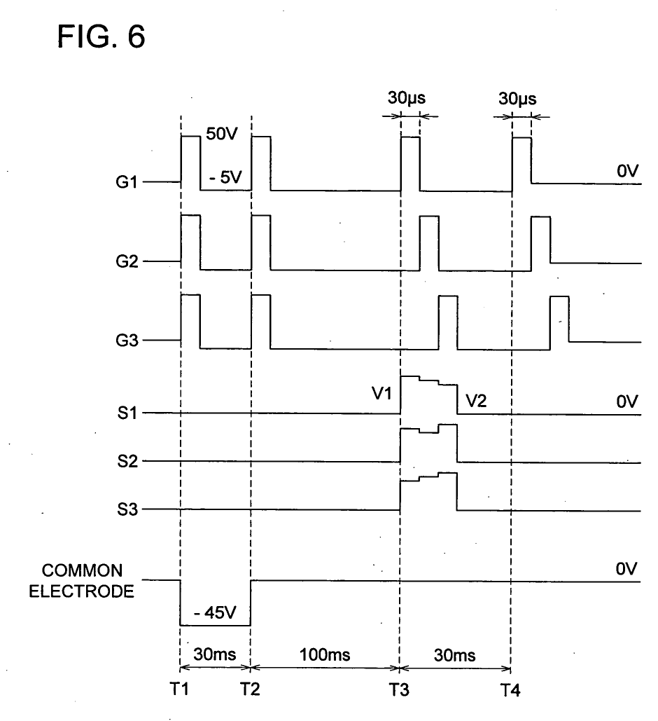

FIG. 6 shows voltage transitions of each component of a liquid crystal display unit which is a third embodiment of this invention. FIG. 6 and FIG. 4 use the same parts for transitions of voltages. Operations of the liquid crystal display unit will be explained below referring to FIG. 6. The third embodiment is the same as the first embodiment in configuration and operation timing of the liquid crystal display unit but voltages of source lines S1, S2, and S3 are different. Although the first embodiment outputs only 0V and a voltage between V4 and V3 from source driver circuit 29, the third embodiment outputs 0V and a voltage between V2 and V1 from source driver circuit 29. With this, liquid crystal layer 24 is written at a voltage between V2 and V1 in FIG. 2.

The third embodiment can display high-contrast images by changing the state of the liquid crystals once initialized in the planar state to the focal-conic state.

In accordance with the third embodiment, only 0V and a voltage between V2 and V1 are output from source driver circuit 29. Therefore, the source driver circuit need not be of the high voltage type and can be low in production cost. The third embodiment can provide a low-cost liquid crystal display unit.

### Fourth Embodiment

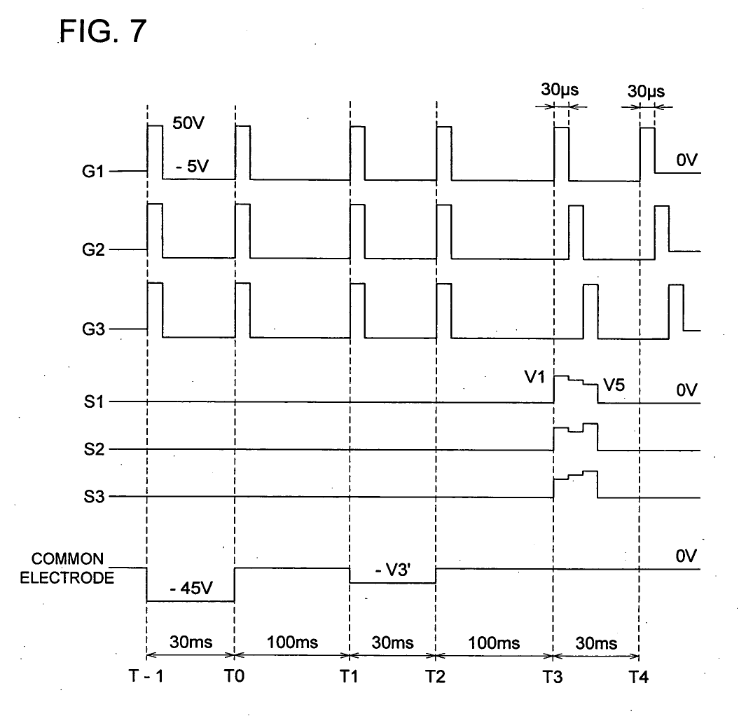

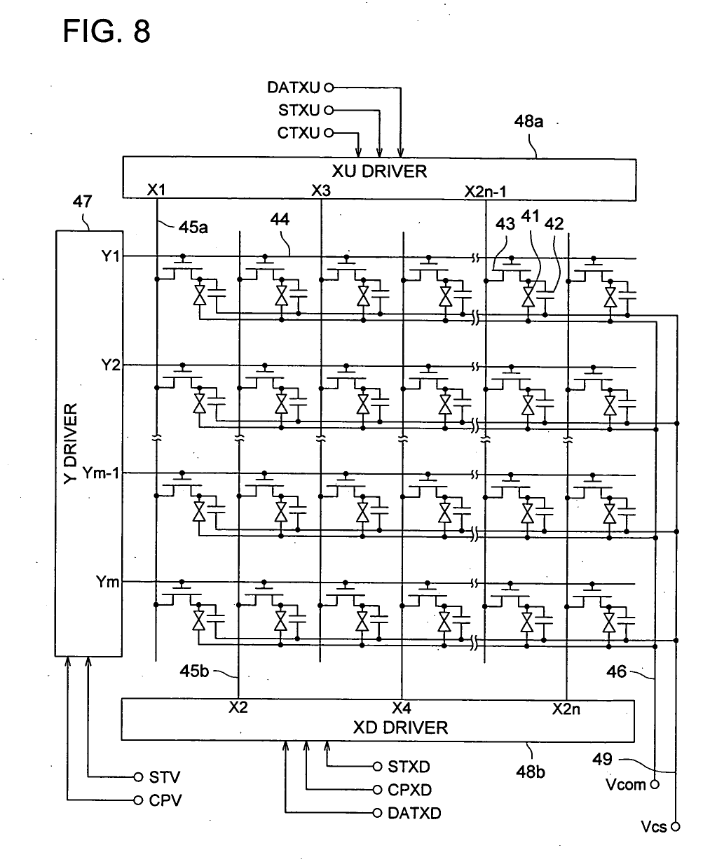

FIG. 7 shows voltage transitions of each component of a liquid crystal display unit which is a fourth embodiment of this invention. FIG. 7 and FIG. 6 use the same parts for transitions of voltages. Operations of the liquid crystal display unit will be explained below referring to FIG. 7. The fourth embodiment is the same as the third embodiment in configuration of the liquid crystal display unit. In the rewriting operation, the third embodiment initializes liquid crystal layer 24 to the planar state in the erasing operation but the fourth embodiment first changes the state of liquid crystal layer 24 to the planar state and then to the focal-conic state. Further in the writing operation, the third embodiment outputs 0V and a voltage between V2 and V1 from source driver circuit 29, but the fourth embodiment outputs 0V and a voltage between V5 and V1 from circuit 29. This is because the fourth embodiment writes on liquid crystal layer 24 in the focal-conic state, therefore it writes at a voltage between V5 and V1 shown in FIG. 2.

At timing between T-1 and T0, the fourth embodiment as well as the other embodiments initializes liquid crystal layer 24 to the planar state. At T0, a voltage of 50V is applied to gate lines G1, G2, and G3 and simultaneously, a voltage of −V3′ is applied to common electrode 23. Voltage V3′ is between V3 and V2 and used to set liquid crystal layer 24 fully in the focal-conic state by applying this voltage to liquid crystal layer 24. At T2, this embodiment applies a voltage of 50V to gate lines G1, G2, and G3 and simultaneously, a voltage of 0V to source lines S1, S2 and S3, then a voltage of 0V to liquid crystal layer 24 and waits 100 ms (between T2 and T3). With this, liquid crystal layer 24 is in a fully focal-conic state. The operation of the fourth embodiment at T3 and later is the same as the third embodiment but the fourth embodiment outputs 0V and a voltage between V5 and V1 from the source driver circuit.

In accordance with the fourth embodiment, voltage −V3′ is applied at T2 to liquid crystal layer 24 by outputting voltage—V3′ from common power supply 30. However, it is also possible to apply 0V from common power supply 30 and V3′ from source driver circuit 29 to liquid crystal layer 24.

Further, the fourth embodiment sets liquid crystal layer 24 in the temporary planar state in the former half of the erasing operation (between T-1 and T1). This process is provided to reduce the history of the previous image more by placing liquid crystal layer 24 in the homeotropic state. This process can be omitted.

The fourth embodiment enables high-contrast displaying by changing the state of the liquid crystals once initialized in the focal conic state to the planar state.

In accordance with the fourth embodiment, only 0V and a voltage between V5 and V1 are output from source driver circuit 29. Therefore, the source driver circuit need not be of the high voltage type and can be low in production cost. The fourth embodiment can provide a low-cost liquid crystal display unit.

As explained above, the liquid crystal display units of embodiments in accordance with this invention can select any liquid crystal material without being limited by its dielectric constant and provide a low-cost liquid crystal display unit which can be rewritten faster than liquid crystal display units of the passive matrix drive type.

According to the preferred embodiment of the present invention, the entire voltage to erase images is applied to the liquid crystal layer without being divided by the capacitance of the liquid crystal layer and the supplementary capacitor. Therefore, liquid crystal materials for the liquid crystal layer can be selected freely without limitation of material selection due to their dielectric constants. Further, the circuits can be simplified and low in production cost since the common electrode and one end of the supplementary capacitors can be driven by a single power supply.

According to another aspect of the preferred embodiment of the present invention, all pixels having images to be erased are cleared simultaneously. This erasing method can clear pixels faster than the erasing method by scanning. In other words, this method can rewrite display images in a short time.

According to another aspect of the preferred embodiment of the present invention, images are erased by changing a voltage applied between the common electrode and one end of supplementary capacitors which are electrically connected. Therefore, a low-voltage circuit can be used as a circuit connected to a pixel electrode. Naturally, this circuit can reduce the production cost of the liquid crystal display unit.

According to another aspect of the preferred embodiment of the present invention, cholesteric liquid crystals are used as the memory-type liquid crystal materials. The cholesteric liquid crystals can accomplish high reflective display units.

According to another aspect of the preferred embodiment of the present invention, the liquid crystal layer is initialized to the planar state after the homeotropic state in the image erasing operation. Therefore, the liquid crystal layer can be initialized without an image history.

According to another aspect of the preferred embodiment of the present invention, the liquid crystal layer is initialized to the focal conic state in the image erasing operation. Therefore, the liquid crystal layer can be initialized without an image history.

According to another aspect of the preferred embodiment of the present invention, there is a time period of 1 ms or more between the end of application of a voltage to the liquid crystal layer and the beginning of writing operation in the above image erasing operation. With this, the liquid crystalline molecules in the liquid crystal layer are fully initialized into the planar state and the liquid crystal layer can show high-contrast images in displaying operation.

According to another aspect of the preferred embodiment of the present invention, an image is written in the liquid crystal layer by applying a voltage of homeotropic voltage or lower to the liquid crystal layer. Therefore, the liquid crystal layer can show high-contrast halftone images.

According to another aspect of the preferred embodiment of the present invention, a voltage of the focal conic voltage or lower is applied to the liquid crystal layer to write an image. With this, the liquid crystal layer can show high-contrast halftone images. Further, this configuration can provide a low-cost liquid crystal display unit since a low-voltage circuit can be used for a source driver circuit.

What is claimed is:

1. A Liquid Crystal Display having a matrix pixels, comprising:
a plurality of pixel electrodes;
a common electrode which faces the plurality of pixel electrodes;
a liquid crystal layer which contains a memory-type liquid crystal material provided between the plurality of pixel electrodes and the common electrode;
a plurality of supplementary capacitors which are provided corresponding to the pixel electrodes;
a plurality of switching elements which are provided corresponding to the pixel electrodes to control connection and disconnection of a voltage to the plurality of the pixel electrodes, and
a common power supply which controls a voltage to the common electrode;
wherein the plurality of pixels include the pixel electrodes, the common electrode, the liquid crystal layer, the supplementary capacitors and the switching elements, and one terminals of the supplementary capacitors are electrically connected to the corresponding pixel electrodes, the other terminals of the supplementary capacitors are electrically connected to the common electrode, and the switching elements and the common power supply operate to update a state of the liquid crystal layer in the following order: an erasing operation, a writing operation and a displaying operation.

2. The liquid crystal display of claim 1, wherein in the erasing operation, the switching elements corresponding to all of the pixels whose images are to be erased go into the state of applying a voltage.

3. The liquid crystal display of claim 1, wherein the common power supply modulates a voltage on the other terminal of the supplementary capacitor and the common electrode.

4. The liquid crystal display of claim 1, wherein the memory-type liquid crystal material is a cholesteric liquid crystal material.

5. The liquid crystal display of claim 4, wherein the liquid crystal layer goes into a planar state by way of a homeotropic states in response to the erasing operation.

6. The liquid crystal display of claim 4, wherein the liquid crystal layer goes into a focal conic state in response to the erasing operation.

7. The liquid crystal display of claim 4, wherein the liquid crystal layer goes into a focal conic state after once going into a planar state in response to the erasing operation.

8. The liquid crystal display of claim 5, wherein the erasing operation includes a step of applying a voltage to the liquid crystal layer, and the writing operation is executed enough time, for the liquid crystal layer to be stabilized, after the step of applying the voltage to the liquid crystal.

9. The liquid crystal display of claim 5, wherein the erasing operation includes a step of applying a voltage to the liquid crystal layer, and the writing operation is executed no less than 1 second after the step of applying the voltage to the liquid crystal layer.

10. The liquid crystal display of claim 7, wherein the erasing operation includes a step of applying a voltage to the liquid crystal layer, and the writing operation is executed no less than 50 seconds after the step of applying the voltage to the liquid crystal layer.

11. The liquid crystal display of claim 4, wherein in the writing operation, a voltage no more than a homeotropic voltage of the liquid crystal layer is applied to the liquid crystal layer.

12. The liquid crystal display of claim 4, wherein in the writing operation, a voltage no more than a focal conic voltage of the liquid crystal layer is applied to the liquid crystal layer.

13. A Liquid Crystal Display having a matrix of pixels, comprising:
a plurality of pixel electrodes;
a common electrode which faces the plurality of pixel electrodes;
a liquid crystal layer which contains a memory-type liquid crystal material provided between the plurality of pixel electrodes and the common electrode;
a plurality of supplementary capacitors which are provided corresponding to the pixel electrodes and are connected to the corresponding pixel electrodes;
a plurality of switching elements which are provided corresponding to the pixel electrodes to control connection and disconnection of a voltage to the plurality of the pixel electrodes, and
a common power supply which controls a voltage to the common electrode, controls the voltage and is connected to the other terminals of the supplementary capacitors and the common electrode;
a gate driver circuit which controls the switching elements on a row to row basis to select a pixel row;
a source driver circuit which supplies a voltage to be applied to the row of pixels selected by the gate driver circuit to the pixel electrodes individually;
wherein the plurality of pixels include the pixel electrodes, the common electrode, the liquid crystal layer, the supplementary capacitors and the switching elements.

14. The liquid crystal display of claim 13, wherein in a period of the erasing operation, the gate driver circuit sets switching elements of the pixels to be erased to ON, and the common power supply applies an erasing voltage to the common electrode to be erased.

15. The liquid crystal display of claim 14, wherein in a period of the erasing operation, all of the pixels to be erased are erased collectively.

16. The liquid crystal display of claim 14, wherein in the writing operation following the erasing operation, the gate driver circuit sets the switching elements in an area to be written on a row to row basis, and the source driver circuit applies a writing voltage to the pixel electrodes to be written in synchronization with an operation of setting the switching elements to ON.

17. The liquid crystal display of claim 16, wherein the switching elements go to ON twice in the each period of the erasing operation and the writing operation.

18. A liquid crystal display having a matrix of pixels, comprising;
a plurality of pixel electrodes;
a common electrode which faces the plurality of pixel electrodes;
a liquid crystal layer which contains a cholesteric liquid crystal material having memory property provided between the plurality of pixel electrodes and the common electrode;
a plurality of supplementary capacitors which are provided corresponding to the pixel electrodes and are connected to the corresponding pixel electrodes;
a plurality of switching elements which are provided corresponding to the pixel electrodes to control connection and disconnection of a voltage to the plurality of the pixel electrodes, and
a common power supply which controls a voltage to the common electrode, controls the voltage and is connected to the other terminals of the supplementary capacitors and the common electrode;
a gate driver circuit which controls the switching elements on a row to row basis to select a pixel row;
a source driver circuit which supplies a voltage to be applied to the row of pixels selected by the gate driver circuit to the pixel electrodes individually;
wherein the plurality of pixels include the pixel electrodes, the common electrode, the liquid crystal layer, the supplementary capacitors and the switching elements.

19. The liquid crystal display of claim 18, wherein the gate driver circuit selects a pixel row contained in an area to be erased, and the common power supply applies an erasing voltage no less than a homeotropic voltage of the liquid crystal layer to the common electrode to erase an image displayed on the pixels selected by the gate driver.

20. The liquid crystal display of claim 18, wherein the gate driver circuit selects a pixel row contained in an area to be erased, and the common power supply modulates a voltage applied to the common electrode to reset the liquid crystal layer to a planar state or a focal conic state.
